(19) United States
(12) Patent Application Publication
(10) Pub. No.: US 2026/0245332 A1
(43) Pub. Date: Aug. 20, 2026

(54) CAMOUFLAGED OBJECT SEGMENTATION METHOD ASSISTED BY ARBITRARY MODALITIES

(71) Applicant: Tsinghua Shenzhen International Graduate School, Shenzhen (CN)

(72) Inventors: Xiu LI, Shenzhen (CN); Chengyu FANG, Shenzhen (CN); Chunming HE, Shenzhen (CN); Longxiang TANG, Shenzhen (CN)

(21) Appl. No.: 19/446,064

(22) Filed: Jan. 12, 2026

(30) Foreign Application Priority Data
Feb. 19, 2025 (CN) 202510183100.0

(51) Int. Cl. G06V 10/26; G06V 10/80; G06V 10/82

(52) U.S. Cl. CPC G06V 10/26; G06V 10/806; G06V 10/82

(57) ABSTRACT

A camouflaged object segmentation method assisted by arbitrary modalities comprises a multi-modal segmenter UniSEG and a cross-modal knowledge learning network UniLearner. UniSEG adopts a dual-branch architecture to extract features from RGB images and images of other modalities respectively, and performs preliminary fusion via a Latent Space Fusion Module (LSFM). A State Space Fusion Mechanism (SSFM) combined with a Cross State Space Model (CSSM) further fuses the features in a unified state space. UniLearner, through an encoder-decoder structure, learns the mapping relationship between RGB images and target modalities, generates pseudo-modal images and semantically rich latent vectors, and injects these vectors into specific layers of UniSEG to enhance feature extraction and fusion effects. This method features plug-and-play flexibility, enabling seamless integration into existing segmentation networks. It is widely applicable to fields such as ecology, medicine, and surface monitoring, significantly improving the performance and robustness of camouflaged object segmentation.

### CROSS REFERENCE TO RELATED APPLICATIONS

This application claims priority to CN patent application NO. CN202510183100.0 filed on 2025 Feb. 19. The contents of the above-mentioned application are all hereby incorporated by reference.

### TECHNICAL FIELD

The present invention relates to computer vision technology, and in particular to a camouflaged object segmentation method assisted by arbitrary modalities.

### BACKGROUND

Camouflaged Object Segmentation (COS) aims to detect targets that are difficult to identify in scenes. This task is highly challenging because the visual information difference between a camouflaged target and its surrounding background is extremely small, lacking obvious visual features, making it difficult for both machines and humans to accurately identify such targets.

In recent years, COS research has made progress driven by technologies such as multi-scale, multi-space, multi-stage, and bionic strategies, with these methods mainly focusing on improving the feature extraction capability for camouflaged images. Nevertheless, most methods still rely on single-modal input, which limits the potential of multi-modal data, mainly due to the difficulty in acquiring multi-modal data paired with camouflaged targets. The development of depth estimation technology has promoted the fusion of depth information, further demonstrating the advantages of multi-modal methods. However, research on RGB-to-other modalities (RGB-to-X) conversion remains limited, which to a certain extent hinders the further development of additional modality-assisted COS tasks.

To overcome the limitations of single-image COS, a common strategy is to introduce auxiliary information from other modalities. For example, IPNet and PolarNet utilize polarization data to improve segmentation accuracy through 1,200 sets of RGB-polarization camouflaged target image pairs. However, these datasets are small in scale, and models trained on such sparse data usually only bring limited performance improvement.

With the development of passive depth estimation technology, the application of depth information in COS tasks has become increasingly widespread. For instance, PopNet introduces depth maps into COS tasks through a specialized network architecture and loss function to enhance segmentation effects. Similarly, DSAM combines the SAM framework to study the interaction between depth and RGB information in the COS field for more effective fusion of these modalities. However, when the target and background are on the same focal plane (as shown in FIG. 1) or there is high visual confusion, monocular depth estimation may fail, leading to reduced depth discrimination ability, thereby significantly affecting the effectiveness of these methods.

Infrared data is a promising modality in target-centered segmentation tasks because it can capture thermal radiation differences of targets, thereby providing effective clues to distinguish camouflaged targets from their surrounding environments. However, introducing infrared data into COS tasks faces significant challenges. Constructing paired datasets of infrared and camouflaged target images is extremely difficult, and there is currently a lack of reliable methods to generate pseudo-infrared data for camouflaged target images. These issues hinder the effective fusion of infrared data and other similar modalities in COS tasks.

Derived from classical control theory, State Space Models (SSMs) are important tools for analyzing continuous long-sequence data. The Structured State Space Sequence Model (S4) was initially used to model long-range dependencies, while the recent Mamba model introduces a selection mechanism that enables it to extract relevant information from input data. Mamba has been successfully applied in fields such as image inpainting and segmentation, achieving competitive performance.

In image fusion tasks, methods such as MambaDFuse and FusionMamba have improved performance using Mamba. However, these methods only use SSM for feature extraction, ignoring cross-modal state space features and Mamba's ability to select features from different modalities.

It should be noted that the information disclosed in the above background art section is only for understanding the background of the present application, and thus may include information that does not constitute the prior art known to those of ordinary skill in the art.

### SUMMARY

The main objective of the present invention is to overcome the defects existing in the aforementioned background art and provide a camouflaged object segmentation method assisted by arbitrary modalities.

To achieve the above objective, the present invention adopts the following technical solution: A camouflaged object segmentation method assisted by arbitrary modalities, comprising the following steps:
S1. Feature extraction: extracting features of RGB images and images of other modalities respectively through two branches of a multi-modal segmenter UniSEG;
S2. Preliminary fusion: performing preliminary fusion of the features of the RGB images and the features of the other modal images through a Latent Space Fusion Module (LSFM);
S3. Further fusion: performing deep fusion of the preliminarily fused features in a unified state space through a State Space Fusion Mechanism (SSFM) and a Cross State Space Model (CSSM);
S4. Generating segmentation results: converting the fused features into final segmentation results through a decoder;
S5. Cross-modal knowledge learning: learning the relationship between RGB and the other modalities by a cross-modal knowledge learning network UniLearner to generate pseudo-modal images and knowledge vectors;
S6. Joint training: injecting the knowledge of the cross-modal knowledge learning network UniLearner into the multi-modal segmenter UniSEG, thereby improving the segmentation performance of UniSEG.

Further, in step S1, when extracting the features of the RGB images and the other modal images, a dual-branch encoder architecture is adopted, wherein the first branch is used to extract the features of the RGB images, the second branch is used to extract the features of the other modal images, and the output features of the two branches have the same spatial resolution.

Further, in step S2, the Latent Space Fusion Module (LSFM) performs weighted fusion of the features of the RGB images and the features of the other modal images to generate fused latent features, and enhances the expressive ability of the features through nonlinear activation functions and convolution operations.

Further, in step S3, the State Space Fusion Mechanism (SSFM) selectively integrates features of different modalities in the unified state space, and the Cross State Space Model (CSSM) captures long-range dependencies between features of different modalities and balances the contribution of each modal feature through a gating mechanism.

Further, in step S4, when generating the segmentation results, a multi-task decoder is adopted, which combines the fused features and preliminary prediction results at each layer to gradually reconstruct the segmentation map, and provides additional supervision information through an edge reconstruction task to enhance the detail and boundary accuracy of the segmentation results.

Further, in step S5, when learning cross-modal knowledge, the cross-modal knowledge learning network UniLearner maps RGB images to the target modal space through an encoder-decoder structure to generate pseudo-modal images and semantically rich latent vectors, and the latent vectors are used to guide the feature extraction and fusion process of the multi-modal segmenter UniSEG.

Further, in step S5, the cross-modal knowledge learning network UniLearner optimizes its parameters through joint training, uses L1 norm loss to constrain the generation of pseudo-modal images, and injects the generated latent vectors into the feature fusion layer of the multi-modal segmenter UniSEG to enhance the utilization of cross-modal semantic information by the segmentation network.

Further, in step S6, during joint training, a weighted loss function is adopted to optimize the multi-modal segmenter UniSEG and the cross-modal knowledge learning network UniLearner, wherein the loss function includes segmentation loss, edge reconstruction loss and cross-modal generation loss to simultaneously improve segmentation performance and cross-modal knowledge learning effect.

Further, the multi-modal segmenter UniSEG specifically includes a Feature Feedback Module (FFM), a State Space Fusion Mechanism (SSFM) and a Cross State Space Model (CSSM), wherein the Feature Feedback Module (FFM) feeds back the preliminarily fused features to the subsequent layers of the other modal encoders, dynamically adjusts feature weights through a gating mechanism to guide the other modal encoders in targeted feature extraction; the State Space Fusion Mechanism (SSFM) selectively integrates RGB image features and other modal features in the unified state space, captures long-range dependencies through a State Space Model (SSM), and balances the contribution of different modal features using a gating mechanism; the Cross State Space Model (CSSM) further fuses different modal features in the state space, enhances feature expression ability through depth convolution and nonlinear activation functions, and reduces feature redundancy by combining a channel attention mechanism to improve the robustness and semantic richness of the fused features.

A computer program product, comprising a computer program, wherein the computer program implements the aforementioned camouflaged object segmentation method assisted by arbitrary modalities when executed by a processor.

### Beneficial Effects of the Present Invention

The present invention provides a camouflaged object segmentation method assisted by arbitrary modalities, which significantly improves the performance of camouflaged object segmentation through an innovative multi-modal fusion framework. The core of the method lies in combining a multi-modal segmenter UniSEG and a cross-modal knowledge learning network UniLearner, realizing an effective transition from single-modal to multi-modal. UniSEG efficiently fuses multi-modal features in a unified state space through a Latent Space Fusion Module (LSFM), a State Space Fusion Mechanism (SSFM), and a Cross State Space Model (CSSM), enhancing the ability to identify camouflaged targets in complex scenes. Meanwhile, UniLearner learns cross-modal mapping using task-irrelevant multi-modal data to generate pseudo-modal images and semantically rich latent vectors, which are embedded into UniSEG to enhance its feature extraction capability. Thus, the segmentation performance is significantly improved even in the absence of real multi-modal data. This fusion-feedback-fusion strategy not only improves the robustness of feature extraction but also enhances the model's resistance to noise, enabling the present invention to exhibit excellent performance and wide applicability in multiple camouflaged object segmentation tasks.

In addition, the modular design of the present invention endows it with high flexibility and scalability. Both UniSEG and UniLearner adopt a plug-and-play architecture, which can be seamlessly integrated into existing segmentation networks to easily convert single-modal networks into multi-modal networks. This design not only simplifies the model deployment process but also allows the method to be easily applied to other related fields, such as camouflaged animal detection in ecological research, lesion segmentation in medical images, and surface change monitoring. Through applications in these fields, the present invention not only improves the detection accuracy of camouflaged targets but also provides new technical means for research and practice in related fields, demonstrating great application potential and value.

Other beneficial effects of the embodiments of the present invention will be further described below.

### BRIEF DESCRIPTION OF THE DRAWINGS

FIG. 1 shows RGB images, their corresponding segmentation ground truths, depth estimation maps generated by PopNet, infrared estimation images generated by a separately trained ResUNet, and infrared images generated by UniLearner with the same network architecture.

FIG. 2 is a framework diagram of the UniCOS framework, as well as FFM, LSFM, g_w, and SSFM according to an embodiment of the present invention.

FIG. 3 is a framework diagram of the CSSM (Cross State Space Module) according to an embodiment of the present invention.

FIG. 4 shows qualitative results of UniCOS-I and other state-of-the-art methods according to an embodiment of the present invention.

FIG. 5 shows visual comparisons in the RGB-D COS task according to an embodiment of the present invention.

FIG. 6 shows visual comparisons in the RGB-P COS task according to an embodiment of the present invention.

FIG. 7 is an overall flowchart of the camouflaged object segmentation method assisted by arbitrary modalities according to the present invention.

### DETAILED DESCRIPTION

The following provides a detailed description of the embodiments of the present invention. It should be emphasized that the following description is merely exemplary and not intended to limit the scope and application of the present invention.

In addition, the terms “first” and “second” are used only for descriptive purposes and shall not be construed as indicating or implying relative importance or implicitly indicating the number of indicated technical features. Thus, features defined as “first” and “second” may explicitly or implicitly include one or more of such features. In the description of the embodiments of the present invention, the term “plurality” means two or more unless otherwise explicitly specified and limited.

In recent years, research on Camouflaged Object Segmentation (COS) has made progress driven by technologies such as multi-scale, multi-space, multi-stage, and bionic strategies, with these methods mainly focusing on improving the feature extraction capability for camouflaged images. Nevertheless, most methods still rely on single-modal input, which limits the potential of multi-modal data, primarily due to the difficulty in acquiring multi-modal data paired with camouflaged targets. The development of depth estimation technology has promoted the fusion of depth information, further demonstrating the advantages of multi-modal methods. However, research on RGB-to-other modalities (RGB-to-X) conversion remains limited, which to a certain extent hinders the further development of additional modality-assisted COS tasks. Derived from classical control theory, State Space Models (SSMs) are important tools for analyzing continuous long-sequence data. The Structured State Space Sequence Model (S4) was initially used to model long-range dependencies, while the recent Mamba model introduces a selection mechanism that enables it to extract relevant information from input data. Mamba has been successfully applied in fields such as image inpainting and segmentation, achieving competitive performance. In image fusion tasks, methods like MambaDFuse and FusionMamba have improved performance using Mamba. However, these methods only use SSM for feature extraction, ignoring cross-modal state space features and Mamba's ability to select features from different modalities.

The present invention mainly addresses the following four problems:
1. Limitations of single-modal methods: Previous RGB single-modal methods have limited visual cues, making it difficult to accurately segment camouflaged targets, especially when the target and background have similar colors and textures;
2. Difficulties in multi-modal data fusion: Although multi-modal data (such as depth, infrared, polarization, etc.) can provide additional visual cues, how to effectively fuse these different modal data to improve segmentation performance is a key issue. For example, depth estimation may fail in certain cases, and the acquisition and fusion of infrared data also face challenges;
3. Lack of paired multi-modal data: In practical applications, it is very difficult to obtain multi-modal data pairs (such as RGB and infrared image pairs) related to camouflaged object segmentation tasks, which limits the development and application of multi-modal methods;
4. Insufficient utilization of cross-modal knowledge: Even if there is multi-modal data of non-camouflaged targets, how to use this data to improve the performance of camouflaged object segmentation models is still an unresolved problem.

To fully utilize effective features, the present invention proposes a State Space Fusion Mechanism (SSFM) combined with a Cross State Space Model (CSSM) to uniformly integrate multi-modal features into a shared state space for efficient fusion. On this basis, the present invention further designs UniSEG, a unified network for Multi-modal Camouflaged Object Segmentation (MCOS) tasks.

To avoid the interference of the uncertainty of pseudo-modal data on feature extraction, UniSEG adopts a Latent Space Fusion Module (LSFM) to perform preliminary feature fusion in the latent space, and feeds the fused results back to the subsequent layers of the additional modal encoder through a Feature Feedback Module (FFM) to provide targeted guidance for feature extraction. Finally, SSFM is used to further fuse cross-modal information in the state space. Through this fusion-feedback-fusion strategy, UniSEG can effectively extract and integrate key multi-modal information, improving the segmentation performance of MCOS tasks.

To more effectively use additional modal information to enhance the performance of COS tasks, the present invention proposes UniLearner, a framework for acquiring cross-modal knowledge from auxiliary RGB-X datasets. Notably, this auxiliary dataset is irrelevant to the COS task itself. UniLearner learns cross-modal mapping to generate pseudo-modal data and a semantically rich latent vector that maps RGB images to the auxiliary modality, thereby providing guidance for the segmentation network. By jointly optimizing UniLearner with the segmentation network, the framework can improve the quality of feature generation, thereby enhancing segmentation performance and achieving better results in cross-domain image conversion tasks.

UniSEG adopts a modular design, enabling it to serve as a plug-and-play enhancement component for existing segmentation networks. Its various modules can seamlessly convert single-modal segmentation networks into multi-modal segmentation networks. In addition, UniLearner can work collaboratively with dual-branch multi-modal segmentation networks to further improve segmentation performance through efficient cross-modal knowledge fusion.

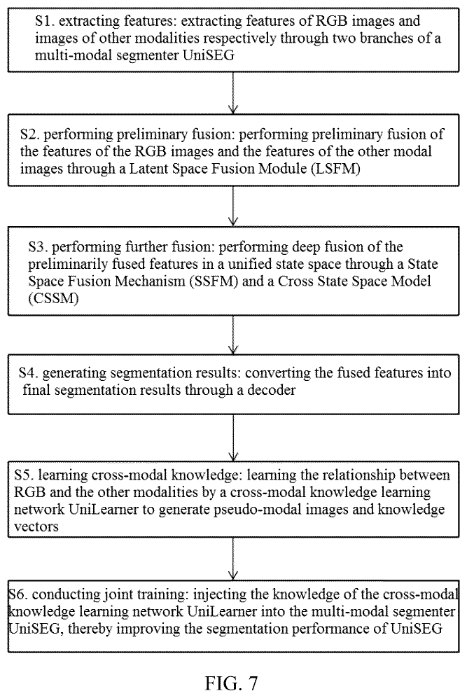

An embodiment of the present invention provides a camouflaged object segmentation method assisted by arbitrary modalities, as shown in FIG. 7, comprising the following steps:
Step S1. Feature extraction: Extract features of RGB images and images of other modalities respectively through two branches of a multi-modal segmenter UniSEG.

In a preferred embodiment, in step S1, when extracting the features of the RGB images and the other modal images, a dual-branch encoder architecture is adopted, wherein the first branch is used to extract the features of the RGB images, the second branch is used to extract the features of the other modal images, and the output features of the two branches have the same spatial resolution.
Step S2. Preliminary fusion: Perform preliminary fusion of the features of the RGB images and the features of the other modal images through a Latent Space Fusion Module (LSFM).

In a preferred embodiment, in step S2, the Latent Space Fusion Module (LSFM) performs weighted fusion of the features of the RGB images and the features of the other modal images to generate fused latent features, and enhances the expressive ability of the features through nonlinear activation functions and convolution operations.
Step S3. Further fusion: Perform deep fusion of the preliminarily fused features in a unified state space through a State Space Fusion Mechanism (SSFM) and a Cross State Space Model (CSSM).

In a preferred embodiment, in step S3, the State Space Fusion Mechanism (SSFM) selectively integrates features of different modalities in the unified state space, and the Cross State Space Model (CSSM) captures long-range dependencies between features of different modalities and balances the contribution of each modal feature through a gating mechanism.
Step S4. Generate segmentation results: Convert the fused features into final segmentation results through a decoder.

In a preferred embodiment, in step S4, when generating the segmentation results, a multi-task decoder is adopted, which combines the fused features and preliminary prediction results at each layer to gradually reconstruct the segmentation map, and provides additional supervision information through an edge reconstruction task to enhance the detail and boundary accuracy of the segmentation results.
Step S5. Cross-modal knowledge learning: Learn the relationship between RGB and the other modalities by a cross-modal knowledge learning network UniLearner to generate pseudo-modal images and knowledge vectors.

In a preferred embodiment, in step S5, when learning cross-modal knowledge, the cross-modal knowledge learning network UniLearner maps RGB images to the target modal space through an encoder-decoder structure to generate pseudo-modal images and semantically rich latent vectors, which are used to guide the feature extraction and fusion process of the multi-modal segmenter UniSEG. Further, the cross-modal knowledge learning network UniLearner optimizes its parameters through joint training, uses L1 norm loss to constrain the generation of pseudo-modal images, and injects the generated latent vectors into the feature fusion layer of the multi-modal segmenter UniSEG to enhance the utilization of cross-modal semantic information by the segmentation network.
Step S6. Joint training: Inject the knowledge of the cross-modal knowledge learning network UniLearner into the multi-modal segmenter UniSEG, thereby improving the segmentation performance of UniSEG.

In a preferred embodiment, in step S6, during joint training, a weighted loss function is adopted to optimize the multi-modal segmenter UniSEG and the cross-modal knowledge learning network UniLearner, wherein the loss function includes segmentation loss, edge reconstruction loss and cross-modal generation loss to simultaneously improve segmentation performance and cross-modal knowledge learning effect.

In a preferred embodiment, the multi-modal segmenter UniSEG specifically includes a Feature Feedback Module (FFM), a State Space Fusion Mechanism (SSFM) and a Cross State Space Model (CSSM), wherein the Feature Feedback Module (FFM) feeds back the preliminarily fused features to the subsequent layers of the other modal encoders, dynamically adjusts feature weights through a gating mechanism to guide the other modal encoders in targeted feature extraction; the State Space Fusion Mechanism (SSFM) selectively integrates RGB image features and other modal features in the unified state space, captures long-range dependencies through a State Space Model (SSM), and balances the contribution of different modal features using a gating mechanism; the Cross State Space Model (CSSM) further fuses different modal features in the state space, enhances feature expression ability through depth convolution and nonlinear activation functions, and reduces feature redundancy by combining a channel attention mechanism to improve the robustness and semantic richness of the fused features.

Further Description of Algorithm Implementation Examples and Experimental Verification of Specific Embodiments of the Present Invention

### UniSEG: A Unified Multi-Modal Segmenter

UniSEG fuses features from RGB images and additional modalities in both the state space and latent space. The framework adopts a Latent Space Fusion Module (LSFM) and a State Space Fusion Mechanism (SSFM) to selectively combine features of RGB images and auxiliary modalities, thereby improving the performance of camouflaged object segmentation. In addition, a Feature Feedback Module (FFM) utilizes the output of LSFM at specific network layers to guide subsequent encoder layers for more effective feature extraction.

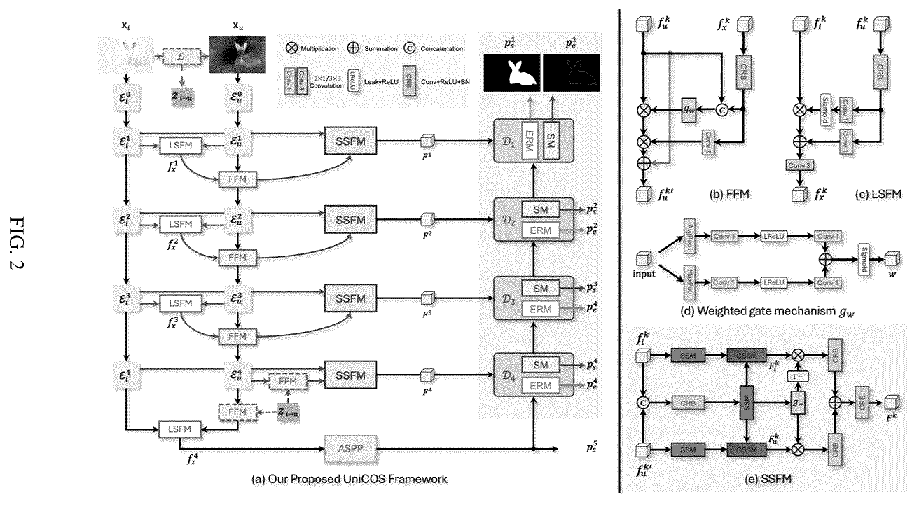

FIG. 2 shows the UniCOS framework of the embodiment of the present invention, as well as the detailed algorithm frameworks of FFM, LSFM, g_{w}, and SSFM. The modules marked by dashed boxes are introduced by UniLearner and can be omitted when using paired RGB-X data.

### Multi-Modal Segmentation-Oriented Encoder

UniSEG adopts a dual-branch encoder architecture to extract and utilize favorable features of different modalities. For inputs Xᵢ and Xᵤ, they are first interpolated to a unified size W×H. Then, a base encoder εᵢ is used to extract a set of deep features

$${\{ {f}_{i}^{k} \}}_{k = 0}^{4}$$

from Xᵢ, where the resolution of each

$${f}_{i}^{k} is \frac{W}{{2}^{k + 1}} \times \frac{H}{{2}^{k + 1}} .$$

To process features from additional modalities, an auxiliary encoder εᵤ with a similar architecture is introduced, which includes a customized embedding layer to adapt to the characteristics of Xᵤ. The output of the k-th layer of the auxiliary encoder is denoted as

$${f}_{u}^{k} ,$$

whose resolution is the same as that of

$${f}_{i}^{k} .$$

To fuse features of different modalities in the latent space, the present invention introduces a Latent Space Fusion Module (LSFM) for fusing features

$${f}_{i}^{k} and {f}_{u}^{k} ∈ {\text{?}}^{B \times C \times H \times W}$$

to generate fused latent features

$${f}_{x}^{k}$$

when k={1, 2, 3, 4}:

$${f}_{x}^{k} = {f}_{i}^{k} ⊙ Sigmoid ( {W}_{c}^{1} \text{?} ( {f}_{u}^{k} ) ) + {W}_{c}^{2} \text{?} ( {f}_{u}^{k} ) , \qquad ( 1 )$$

where W_{c} represents a convolution operation, [symbol] denotes a combined block of Conv+Leaky ReLU (LReLU)+Batch Normalization (BN), and ⊙ represents element-wise multiplication. The final fused latent feature map

$${f}_{x}^{4}$$

has rich semantic information and is further processed through an Atrous Spatial Pyramid Pooling (ASPP) module Aₛ to obtain an initial prediction

$${p}_{s}^{5} = {W}_{c} ( {A}_{s} ( {f}_{x}^{5} ) ,$$

whose spatial resolution is the same as that of

$${f}_{x}^{4}$$

and serves as the initial input to the decoder.

Unlike

$${f}_{x}^{4} ,$$

the function of

$${\{ {f}_{x}^{k} \}}_{k = 1}^{3}$$

is to use existing features to guide εᵤ in extracting targeted features from additional modalities. To achieve this goal, UniSEG introduces a Feature Feedback Module (FFM) to inject

$${f}_{x}^{k} into {f}_{u}^{k}$$

in a gated manner, generating updated features

$${f}_{u}^{{k}^{′}} ,$$

which will simultaneously serve as the input to the (k+1)-th layer of εᵤ and the input to the State Space Fusion Mechanism (SSFM) after the k-th layer:

$$\begin{matrix}α = Sigmoid ( {W}_{c}^{1} conca [ {f}_{u}^{k} , {\text{?}}_{1} ( {f}_{x}^{k} ) ] ) , \\ {f}_{u}^{{k}^{′}} = {𝒞}_{2} ( ( {f}_{u}^{k} ⊙ α ⊙ {W}_{c}^{2} {𝒞}_{1} ( {f}_{x}^{k} ) ) + {f}_{u}^{k} )\end{matrix} \qquad ( 2 )$$

To achieve robust feature fusion, the present invention proposes a State Space Fusion Mechanism (SSFM) for selectively integrating features from different modalities in a unified state space representation:

$$\begin{matrix}{F}^{k} = SSFM ( {W}_{c}^{1} {f}_{i}^{k} , {W}_{c}^{2} {f}_{u}^{{k}^{′}} ) , \\ {W}_{c}^{1} {f}_{i}^{k} , {W}_{c}^{2} {f}_{u}^{k ′ ′} ∈ {ℝ}^{B \times {d}_{m} \times H \times W}\end{matrix} \qquad ( 3 )$$

The obtained

$${\{ {F}^{k} \}}_{k = 1}^{4}$$

provides more complete contextual information, reduces redundancy, filters out noise, and captures relationships between different modalities.

In the decoding stage, each layer of the decoder takes F^{k} as a conditional input and combines the initial prediction

$${p}_{s}^{5}$$

processed by Aₛ and latent space fusion features to enhance the reconstruction process, enabling it to extract richer detailed information and improve modal perception capability.

### Detailed Information of SSFM

### State Space Fusion Mechanism (SSFM)

In the visual state space model with a two-dimensional selective scanning module, features are flattened into sequences and scanned along four directions (from top-left to bottom-right, bottom-right to top-left, top-right to bottom-left, and bottom-left to top-right) to capture long-range dependencies of each sequence using discrete state space equations. The present invention proposes a Cross State Space Model (CSSM) to facilitate information interaction between different sequences in the state space.

In Equation (3), the present invention reshapes

$${f}_{i}^{k} and {f}_{u}^{{k}^{′}}$$

into [symbol] ^{B×H×W×d}^{ₘ}. The present invention implements the visual State Space Module (SSM) as a residual state space block, as shown in MambaIR, and uses it as a long-range self-attention mechanism to process

$${f}_{i}^{k} and {f}_{u}^{{k}^{′}}$$

for calculating intra-modal correlations:

$${\tilde{{f}_{i}}}^{k} = SSM ( {f}_{i}^{k} ) , {\tilde{f}}_{u}^{k} = SSM ( {f}_{u}^{{k}^{′}} ) , \qquad ( 4 )$$

Subsequently, the proposed Cross State Space Model (CSSM) further fuses bimodal features in the state space to handle both intra-modal and cross-modal correlations:

$${\tilde{f}}_{x}^{k} = SSM ( 𝒞 ( conca ( {f}_{i}^{k} , {f}_{u}^{{k}^{′}} ) ) ) , {F}_{i}^{k} = CSSM ( {\tilde{{f}_{i}}}^{k} , {\tilde{f}}_{x}^{k} ) , {F}_{u}^{k} = CSSM ( {\tilde{f}}_{u}^{k} , {\tilde{f}}_{x}^{k} ) \qquad ( 5 )$$

The present invention uses a weighted gating mechanism g_{w} to merge the transformed features, as follows:

$${F}^{k} = C ( C ( {g}_{w} {F}_{i}^{k} + {\tilde{f}}_{x}^{k} ) + 𝒞 ( ( 1 - {g}_{w} ) {F}_{u}^{{k}^{′}} + {\tilde{f}}_{x}^{k} ) ) , {g}_{w} = Sigmoid ( {λ}_{q} conca [ {δ}_{1} , {δ}_{2} ] + {μ}_{q} ) , {δ}_{1} = F ( {\tilde{f}}_{x}^{k} , θ ) , {δ}_{2} = ℱ ( {\tilde{f}}_{x}^{k} + {δ}_{1} , θ ) . \qquad ( 6 )$$

This gating mechanism balances the contributions of

$${F}_{i}^{k} and {F}_{u}^{{k}^{′}}$$

under the guidance of

$${\tilde{f}}_{x}^{k} .$$

The functions δ₁= [symbol] ^{B×H×W×d}^{ₘ} and

$${δ}_{2} = ℱ ( {\tilde{f}}_{x}^{k} + {δ}_{1} , θ )$$

generate intermediate signals that influence the final fused features. By using Sigmoid, g_{w} is constrained between 0 and 1, thereby adjusting the relative contribution of each path to the output F^{k}.

### Cross State Space Model (CSSM)

Let the inputs be

$${\tilde{f}}_{n}^{k} , {\tilde{f}}_{x}^{k} ∈ {\text{?}}^{B \times H \times W \times {d}_{m}} , where {\tilde{f}}_{n}^{k}$$

can be

$${\tilde{{f}_{i}}}^{k} or {\tilde{f}}_{u}^{k}$$

as shown in Equation (5). The present invention first applies linear projection to expand the channel dimensions of

$${\tilde{f}}_{n}^{k} and {\tilde{f}}_{x}^{k}$$

to d×2, and splits them into two parts along the last dimension:

$${\tilde{f}}_{n}^{{k}^{′}} , {\tilde{{f}_{x}}}^{{k}^{′}} ,$$

as well as

$${z}_{n}^{k} , {z}_{x}^{k} ∈ {\text{?}}^{B \times H \times W \times d}$$

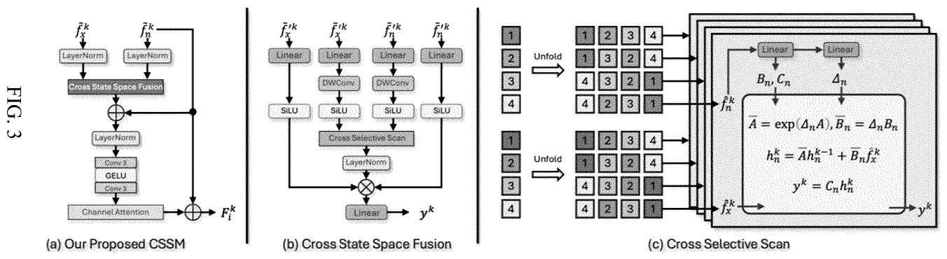

FIG. 3 shows the detailed algorithm framework of the CSSM (Cross State Space Module) according to an embodiment of the present invention.

Next, the present invention regards

$${\tilde{f}}_{n}^{{k}^{′}} and {\tilde{f}}_{x}^{{k}^{′}}$$

as having the shape [symbol] ^{B×d×H×W}, applies depthwise convolution with a kernel size of d_{conv}, and then performs nonlinear activation:

$${\hat{f}}_{n}^{k} = SiLU ( {W}_{c}^{1} ( {\tilde{f}}_{n}^{{k}^{′}} ) ) , {\hat{f}}_{x}^{k} = SiLU ( {W}_{c}^{2} ( {\tilde{f}}_{x}^{{k}^{′}} ) ) , \qquad ( 7 )$$

where the number of convolution groups is equal to the channel dimension d, SiLU is an activation function, and W_{c} represents a convolution layer. To fuse the two modalities in the state space, the present invention constructs the following model:

$$\overline{A} = exp ( {Δ}_{n} A ) , {\overline{B}}_{n} = {Δ}_{n} {B}_{n} \qquad ( 8 )$$

$${h}_{n}^{k} = \overline{A} {h}_{n}^{k - 1} + {\overline{B}}_{n} {\hat{f}}_{x}^{k} , {y}^{k} = {C}_{n} {h}_{n}^{k} ,$$

Here, Bₙ, Cₙ, and Δₙ correspond to matrices B, C, and Δ with selective mechanism parameters

$$B ( {\hat{f}}_{n}^{k} ) = {Linear}_{N} ( {\hat{f}}_{n}^{k} ) and sC ( {\hat{f}}_{n}^{k} ) = {Linear}_{N} ( {\hat{f}}_{n}^{k} ) .$$

After combining the sequences from four directions, the present invention applies layer normalization to y^{k} and performs element-wise multiplication with the activated values of

$$and {z}_{x}^{k} :$$

$${y}^{′ k} = L a y e r N o r m ( {y}^{k} ) ⊙ SiL U ( {z}_{n}^{k} ) ⊙ SiL U ( {z}_{x}^{k} ) , \qquad ( 9 )$$

Subsequently, the present invention maps y′^{k} back to the required output dimension:

$${Y}^{k} = {y}^{′ k} {W}_{l} + {b}_{l} , \qquad ( 10 )$$

$$where {W}_{l} ∈ {ℝ}^{d \times {d}_{m}} , {b}_{l} ∈ {ℝ}^{{d}_{m}} , and {Y}^{k} ∈ {ℝ}^{B \times H \times W \times {d}_{m}} .$$

Finally, to enhance the expressive ability of different channels, the present invention introduces a Channel Attention (CA) mechanism into the CSSM to reduce channel redundancy. In addition, the present invention uses two weighted residual connections, denoted s and s′∈ [symbol] ^{C}, to improve the robustness of the network:

$${F}^{k} = C A ( {W}_{c} ( L a y e r N o r m ( {Y}^{k} + s {\tilde{f}}_{n}^{k} ) ) ) + {s}^{′} {\tilde{f}}_{n}^{k} , \qquad ( 11 )$$

### Replaceable Segmentation Decoder

Due to the plug-and-play design of the multi-modal segmentation-oriented encoder of the present invention, the decoder in UniSEG can be replaced with any decoder that uses rough results, latent maps, and skip connections as inputs.

In the implementation of the present invention, a multi-task segmentation decoder (such as ICEG) is used by default. This decoder has separate task heads at each layer for segmentation and edge reconstruction, where edge reconstruction provides additional supervision information. The decoding process can be expressed by the following formula:

$${\{ {p}_{s}^{k} \}}_{k = 1}^{4} , {\{ {p}_{e}^{k} \}}_{k = 1}^{4} = 𝒟 ( {p}_{s}^{5} , {\{ {F}^{k} \}}_{k = 1}^{4} ) , \qquad ( 12 )$$

where [symbol] denotes the decoder, and

$${\{ {p}_{s}^{k} \}}_{k = 1}^{4} and {\{ {p}_{e}^{k} \}}_{k = 1}^{4}$$

represent segmentation results and reconstructed edges, respectively.

### Optimization

As a unified plug-and-play method, the multi-modal segmentation-oriented encoder and multi-space fusion of the present invention can be easily integrated into most decoders designed for non-specialized inputs. Here, a multi-task segmentation decoder is taken as an example as the default decoder.

UniSEG adopts weighted Intersection over Union (IoU) loss L_{I} and weighted Binary Cross-Entropy (BCE) loss L_{B} to constrain the segmentation results

$${\{ {p}_{s}^{k} \}}_{k = 1}^{5} ,$$

and uses Dice loss L_{D} to supervise the edge reconstruction results

$${\{ {p}_{e}^{k} \}}_{k = 1}^{4} .$$

Let yₛ (segmentation result) and yₑ (edge result) be the ground truth labels; the total loss of UniSEG can be expressed as:

$${L}_{𝒮} = {\sum }_{k = 1}^{5} \frac{1}{{2}^{k - 1}} ( {L}_{B} ( {p}_{s}^{k} , {y}_{s} ) + {L}_{I} ( {p}_{s}^{k} , {y}_{s} ) ) + {\sum }_{k = 1}^{4} \frac{1}{{2}^{k - 1}} {L}_{D} ( {p}_{e}^{k} , {y}_{e} ) . \qquad ( 13 )$$

### UniLearner: Cross-Modal Knowledge Learning

UniLearner [symbol] is a plug-and-play encoder-decoder network. When the COS dataset lacks corresponding multi-modal data, UniLearner can learn the mapping relationship between images and modalities by introducing additional non-COS multi-modal datasets, thereby assisting in completing the COS task.

Specifically, the present invention denotes images of the introduced additional dataset as eᵢ and the corresponding additional modal data as eᵤ. The present invention expects [symbol] to learn the mapping relationship between them, resulting in:

$$\dot{{e}_{u}} = ℒ ( {e}_{i} ) , \dot{{e}_{u}} \to {e}_{u} , \qquad ( 14 )$$

When working collaboratively with UniSEG, UniLearner takes an image xₗ as input and obtains the corresponding pseudo-modality xᵤ and a latent vector z_{i→u} through the encoding-decoding process, where the latent vector embodies the mapping knowledge between the image and the modality:

$${x}_{u} = {ℒ}_{𝒟} ( {z}_{i \to u} ) , {z}_{i \to u} = {ℒ}_{ℰ} ( {x}_{i} ) , \qquad ( 15 )$$

where [symbol] _{ε} and [symbol] are the encoder and decoder of [symbol] , respectively, and z_{i→u} represents a latent vector containing the mapping knowledge from xᵢ to xᵤ.

To integrate z_{i→u} into the segmentation process, the present invention injects it into the 4th layer of UniSEG by replacing the LSFM (Equation (1)) with the following new formula:

$${f}_{x}^{4} = {f}_{i}^{4} ⊙ Sigmoid ( {W}_{c}^{1} 𝒞 ( FFM ( {f}_{u}^{4} , {z}_{i \to u} ) ) ) + {W}_{c}^{2} 𝒞 ( FFM ( {f}_{u}^{4} , {z}_{i \to u} ) ) , \qquad ( 16 )$$

This operation fuses the mapping information between the image and the pseudo-modality, as well as the semantic information extracted from the two modalities, into the latent space. This unified representation enhances the segmentation effect by leveraging complementary cross-modal knowledge.

### Optimization

When UniLearner is used, the present invention performs joint training of UniLearner and UniSEG, optimizing the parameters of both networks using a shared optimizer. To enable UniLearner to learn the mapping relationship between eᵢ and eᵤ, the present invention adopts L1 norm loss, expressed by the formula:

$${L}_{ℒ} = {‖ \dot{{e}_{u}} - {e}_{u} ‖}_{1} , \qquad ( 17 )$$

The total loss Lₜ of this joint training setup is expressed as:

$${L}_{t} = {L}_{𝒮} + {L}_{ℒ} , \qquad ( 18 )$$

### Experiments and Effects

The performance of the method of the present invention was evaluated on three multi-modal COS tasks: RGB-Infrared (RGB-I), RGB-Depth (RGB-D), and RGB-Polarization (RGB-P).

For the RGB-Infrared task (UniCOS-I), a dataset irrelevant to the COS task was used to demonstrate UniLearner's ability to improve COS task performance by leveraging irrelevant data. For the RGB-Depth task (UniCOS-D), pseudo-depth data was used, while for the RGB-Polarization task (UniCOS-P), real Degree of Linear Polarization (DoLP) data was used. This experimental setup comprehensively evaluates the performance and robustness of UniSEG in processing both pseudo-multi-modal and real multi-modal data.

For UniLearner, a ResUNet with 9 residual blocks was adopted as the backbone network. For UniSEG, PVTv2 pre-trained on ImageNet was used by default, and experimental results based on ResNet50 were also provided for fair comparison. All results were evaluated using consistent task-specific evaluation tools.

### Quantitative and Qualitative Results

### RGB and Task-Irrelevant Infrared Data

Table 1 shows the quantitative comparison of UniCOS-I with 12 other State-of-the-Art (SOTA) methods using two different types of backbone networks. Red indicates the best results.

TABLE 1

| | CHAMELEON | | | | CAMO | | | | COD10K | | | | NC4K | | | |
|---|---|---|---|---|---|---|---|---|---|---|---|---|---|---|---|---|
| Methods | M ↓ | F [symbol] ↑ | E [symbol] ↑ | S [symbol] ↑ | M ↓ | F [symbol] ↑ | E [symbol] ↑ | S [symbol] ↑ | M ↓ | F [symbol] ↑ | E [symbol] ↑ | S [symbol] ↑ | M ↓ | F [symbol] ↑ | E [symbol] ↑ | S [symbol] ↑ |

CNNs-Based Methods (ResNet50 Backbone)

| | | | | | | | | | | | | | | | | |
|---|---|---|---|---|---|---|---|---|---|---|---|---|---|---|---|---|
| SINet (Fan et al., 2020) | 0.034 | 0.823 | 0.936 | 0.872 | 0.092 | 0.712 | 0.804 | 0.745 | 0.043 | 0.6 [symbol] 7 | 0.864 | 0.776 | 0.058 | 0.768 | 0.871 | 0.808 |
| LSR (Lv et al., 2021) | 0.030 | 0.835 | 0.935 | 0.890 | 0.080 | 0.756 | 0.838 | 0.787 | 0.037 | 0.699 | 0.880 | 0.804 | 0.048 | 0.802 | 0.890 | 0.834 |
| SLT-Net (Cheng et al., 2022) | 0.030 | 0.835 | 0.940 | 0.887 | 0.082 | 0.763 | 0.848 | 0.792 | 0.036 | 0.681 | 0.875 | 0.804 | 0.049 | 0.787 | 0.886 | 0.830 |
| SegMaR-I (Jia et al., 2022) | 0.028 | 0.82 [symbol] | 0.944 | 0.892 | 0.072 | 0.772 | 0.861 | 0.805 | 0.035 | 0.69 [symbol] | 0.890 | 0.813 | 0.052 | 0.767 | 0.885 | 0.8 [symbol] 5 |
| OSFormer (Pei et al., 2022) | 0.028 | 0.836 | 0.939 | 0.891 | 0.073 | 0.767 | 0.858 | 0.799 | 0.034 | 0.701 | 0.881 | 0.811 | 0.049 | 0.790 | 0.891 | 0.832 |
| FEDER (He et al., 2023) | 0.028 | 0.850 | 0.944 | 0.892 | 0.070 | 0.775 | 0.870 | 0.802 | 0.032 | 0.71 [symbol] | 0.892 | 0.810 | 0.046 | 0.808 | 0.900 | 0.842 |
| FGANet (Zbai et al., 2023) | 0.030 | 0.838 | 0.945 | 0.891 | 0.070 | 0.769 | 0.86 [symbol] | 0.800 | 0.032 | 0.708 | 0.894 | 0.803 | 0.047 | 0.800 | 0.891 | 0.837 |
| FocusDiff (Zhao et al., 2024) | 0.028 | 0.843 | 0.938 | 0.890 | 0.0 [symbol] | 0.772 | 0.883 | 0.812 | 0.031 | 0.730 | 0.897 | 0.820 | 0.044 | 0.810 | 0.902 | 0.850 |
| FSEL (S [symbol] et al., 2024) | 0.029 | 0.847 | 0.941 | 0.893 | 0.069 | 0.779 | 0.881 | 0.816 | 0.032 | 0.722 | 0.891 | 0.822 | 0.045 | 0.807 | 0.901 | 0.847 |
| UniCOS-I ( [symbol] ) | 0.0 [symbol] 4 | 0.8 [symbol] | 0. [symbol] 1 | 0.902 | 0.06# | 0.787 | 0.878 | 0.81 [symbol] | 0.02 [symbol] | 0.757 | 0. [symbol] | 0.8 [symbol] | 0.012 | 0. [symbol] | 0.910 | 0.857 |

Transformers-Based Methods (PVTv2 Backbone)

| | | | | | | | | | | | | | | | | |
|---|---|---|---|---|---|---|---|---|---|---|---|---|---|---|---|---|
| HitNet (Hu et al., 2023) | 0.024 | 0.861 | 0.944 | 0.907 | 0.060 | 0.791 | 0.892 | 0.834 | 0.027 | 0.790 | 0.922 | 0.847 | 0.042 | 0.825 | 0.911 | 0.8 [symbol] 8 |
| DaCOD (Wang et al., 2023 [symbol] ) | 0.026 | 0.824 | 0.939 | 0.893 | 0.051 | 0.831 | 0.905 | 0.8 [symbol] | 0.028 | 0.740 | 0.907 | 0.840 | 0.035 | 0.833 | 0.924 | 0.874 |
| RISNet (Wang et al., 2024 [symbol] ) | — | — | — | — | 0.050 | 0.844 | 0.922 | 0.870 | 0.025 | 0.804 | 0.931 | 0.873 | 0.037 | 0.851 | 0.925 | 0.882 |
| UniCOS-I (Ours) | 0.019 | 0.884 | 0.962 | 0. [symbol] | 0.048 | 0.84 [symbol] | 0. [symbol] 23 | 0.870 | 0.021 | 0.809 | 0.933 | 0.83 [symbol] | 0.032 | 0.8 [symbol] 9 | 0.932 | 0. 887 |

[symbol]

indicates data missing or illegible when filed

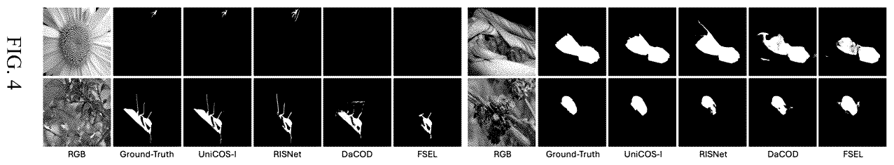

FIG. 4 shows the qualitative results of UniCOS-I and other state-of-the-art methods.

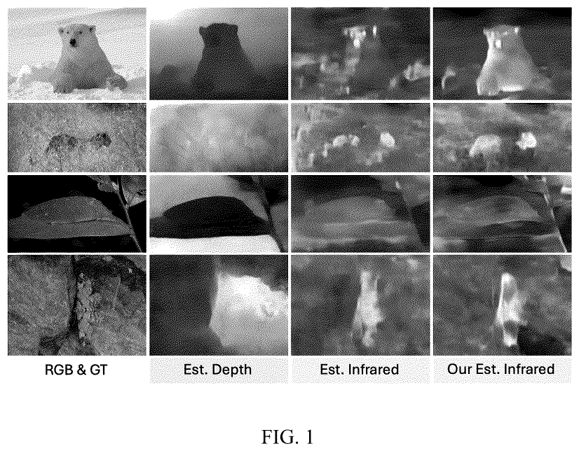

As shown in Table 1, the proposed UniCOS-I method outperforms all 12 latest advanced methods on multiple datasets. The visual performance, as illustrated in FIG. 4, shows that the segmentation maps generated by UniCOS-I are more complete and coherent compared to those of other leading methods, which further confirms the effectiveness of the present invention in multi-modal data fusion. In addition, as shown in FIG. 1, the joint training of UniSEG and UniLearner significantly improves the RGB-to-infrared reconstruction performance. This indicates that UniLearner can effectively handle the inherent semantic complexity in RGB-infrared data, a complexity that traditional end-to-end image conversion methods often struggle to address.

### Paired RGB and Pseudo-Depth Data

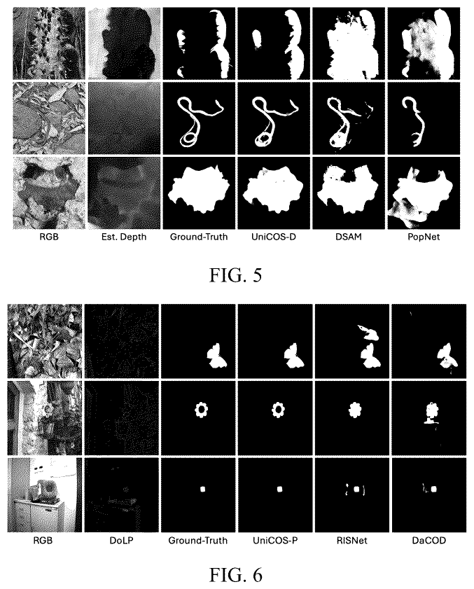

FIG. 5 shows the visual comparisons in the RGB-D COS task.

Table 2 presents the results of RGB-D COS. All methods were trained using passive depth data provided by PopNet.

TABLE 2

| | CHAMELEON | | | | CAMO | | | | COD10K | | | | NC4K | | | |
|---|---|---|---|---|---|---|---|---|---|---|---|---|---|---|---|---|
| Methods | M ↓ | F [symbol] ↑ | E [symbol] ↑ | S [symbol] ↑ | M ↓ | F [symbol] ↑ | E [symbol] ↑ | S [symbol] ↑ | M ↓ | F [symbol] ↑ | E [symbol] ↑ | S [symbol] ↑ | M ↓ | F [symbol] ↑ | E [symbol] ↑ | S [symbol] ↑ |
| CDINet (Zha [symbol] g et al., 2021a) | 0.036 | 0.787 | 0.903 | 0.879 | 0.100 | 0.638 | 0.766 | 0.732 | 0.044 | 0.610 | 0.821 | 0.778 | 0.067 | 0.697 | 0.830 | 0.793 |
| DCMF (Wang et al., 2022a) | 0.059 | 0.807 | 0.853 | 0.830 | 0.115 | 0.737 | 0.757 | 0.728 | 0.063 | 0.679 | 0.776 | 0.748 | 0.077 | 0.782 | 0.820 | 0.794 |
| SPSN (Lee et al., 2022) | 0.032 | 0.866 | 0.932 | 0.887 | 0.084 | 0.782 | 0.829 | 0.773 | 0.042 | 0.727 | 0.854 | 0.789 | 0.059 | 0.803 | 0.867 | 0.813 |
| DCF (Ji et al., 2021) | 0.037 | 0.821 | 0.923 | 0.850 | 0.089 | 0.724 | 0.834 | 0.749 | 0.040 | 0.685 | 0.864 | 0.766 | 0.061 | 0.765 | 0.878 | 0.791 |
| CMINet (Zha [symbol] g et al., 2021b) | 0.032 | 0.881 | 0.930 | 0.891 | 0.087 | 0.798 | 0.827 | 0.782 | 0.039 | 0.768 | 0.868 | 0.811 | 0.053 | 0.832 | 0.888 | 0.839 |
| SPNet (Zhou et al., 2021) | 0.033 | 0.872 | 0.930 | 0.888 | 0.083 | 0.807 | 0.831 | 0.783 | 0.037 | 0.776 | 0.869 | 0.808 | 0.054 | 0.828 | 0.874 | 0.825 |
| PopNet (Wu et al., 2023) | 0.022 | 0.893 | 0.962 | 0.910 | 0.073 | 0.821 | 0.869 | 0.806 | 0.031 | 0.789 | 0.897 | 0.827 | 0.043 | 0.852 | 0.908 | 0.852 |
| DSAM (Yu et al., 2024) | 0.028 | 0.877 | 0.957 | 0.883 | 0.061 | 0.834 | 0.920 | 0.832 | 0.033 | 0.807 | 0.931 | 0.846 | 0.040 | 0.862 | 0.940 | 0.871 |
| UniCOS-D | 0.020 | 0.901 | 0.965 | 0.918 | 0.049 | 0.853 | 0.923 | 0.866 | 0.022 | 0.807 | 0.932 | 0.871 | 0.033 | 0.872 | 0.943 | 0.882 |

[symbol]

indicates data missing or illegible when filed

In the RGB-D task, the proposed UniCOS-D model effectively addresses the challenge of camouflaged object segmentation by leveraging pseudo-depth data paired with RGB images. The quantitative results in Table 2 demonstrate that UniCOS-D outperforms competing methods across all evaluation metrics, achieving the highest scores. Additionally, the visual comparisons in FIG. 5 show that UniCOS-D can clearly distinguish foreground targets from the background. Furthermore, refer to FIG. 1, which shows RGB images, their corresponding segmentation ground truths, depth estimation maps generated by PopNet, infrared estimation images generated by a separately trained ResUNet, and infrared images generated by UniLearner with the same network architecture. The method of the present invention exhibits excellent performance in the RGB-to-infrared conversion task, capable of more accurately presenting the structure and position information of camouflaged targets, thereby improving segmentation performance. Even in cases with limited depth information (as shown in the first row of FIG. 1), UniCOS-D still maintains outstanding segmentation performance. These results verify the robustness of the method of the present invention and its effectiveness under complex conditions.

### Paired RGB and Real Polarization Data

FIG. 6 shows the visual comparisons in the RGB-P COS task.

TABLE 3

| Methods | M ⬇ | F [symbol] ↑ | E [symbol] ↑ | S [symbol] ↑ |
|---|---|---|---|---|
| SINet-V2 (Fan et al., 2021) | 0.013 | 0.819 | 0.941 | 0.882 |
| OCENet (Lin et al., 20226) | 0.013 | 0.827 | 0.945 | 0.883 |
| ZoomNet (Pang et al., 2022) | 0.010 | 0.842 | 0.922 | 0.897 |
| BSANet (Zhu et al., 2022) | 0.011 | 0.861 | 0.945 | 0.903 |
| ERRNet (Ji et al., 2022) | 0.023 | 0.704 | 0.901 | 0.833 |
| C2FNet-V2 (Chen et al., 2022) | 0.012 | 0.845 | 0.945 | 0.895 |
| PGSNet (Mei et al., 2022) | 0.010 | 0.868 | 0.965 | 0.916 |
| CMX (Zhang et al., 2023) | 0.009 | 0.876 | 0.965 | 0.922 |
| DaCOD (Wang et al., 2023a) | 0.011 | 0.846 | 0.959 | 0.899 |
| IPNet (Wang et al., 2024b) | 0.008 | 0.882 | 0.970 | 0.922 |
| RISNet (Wang et al., 2024a) | 0.007 | 0.904 | 0.971 | 0.933 |
| UxiCOS-P | 0.006 | 0.938 | 0.975 | 0.937 |

[symbol]

indicates data missing or illegible when filed

In the RGB-P task, the proposed UniCOS-P model significantly enhances camouflaged target detection capability by combining real Degree of Linear Polarization (DoLP) data with RGB images. As shown in Table 3, UniCOS-P achieves excellent results on the PCOD1200 dataset. With the aid of polarization information, the model can reveal details that are difficult to perceive with traditional RGB sensors. These polarization cues are crucial for accurately depicting target boundaries; as illustrated in FIG. 6, UniCOS-P excels in segmenting tiny features and precisely outlining edges. The success of UniCOS-P in complex scenes indicates that integrating real polarization data can provide significant advantages, enabling clear visualization of targets that are difficult to detect with traditional imaging systems.

### Impact of UniSEG

Table 4 shows the impact of UniSEG: εᵤ and εᵢ represent the encoders for the additional modality and RGB images, respectively, each equipped with corresponding fusion modules.

TABLE 4

| | w/o | Effect of UniSEG | | | | | UniCOS-D |
|---|---|---|---|---|---|---|---|
| Metrics | εᵤ | w/o εᵢ | w/o SSFM | w/o CSSM | w/o LSFM | w/o FFM | (Ours) |
| M ↓ | 0.025 | 0.059 | 0.024 | 0.023 | 0.021 | 0.021 | 0.022 |
| F_{β} ↑ | 0.770 | 0.579 | 0.792 | 0.798 | 0.802 | 0.812 | 0.807 |
| E_{φ} ↑ | 0.923 | 0.785 | 0.927 | 0.931 | 0.934 | 0.937 | 0.932 |
| S_{α} ↑ | 0.867 | 0.713 | 0.873 | 0.876 | 0.877 | 0.880 | 0.871 |

As illustrated in Table 4, UniSEG significantly improves segmentation performance by integrating multi-modal data. When the additional modality encoder εᵤ or the image encoder εᵢ is removed, the segmentation accuracy drops sharply, indicating their importance in the system. In addition, removing state space-based fusion mechanisms (such as SSFM or CSSM) or LSFM adversely affects performance metrics, which further verifies the key role of these components in enhancing the robustness and accuracy of the model. Meanwhile, the removal of FFM also leads to performance degradation, demonstrating the importance of FFM in optimizing feature fusion across stages.

### Impact of UniLearner

Table 5 shows the impact of UniLearner: “Know-Inject” refers to the process of integrating z_{i→u} to guide segmentation.

TABLE 5

| | Effect of UniLearner | | UniCOS-I |
|---|---|---|---|
| Metrics | w/o Know-Inject | only Know-Inject | (Ours) |
| M ↓ | 0.024 | 0.023 | 0.021 |
| F_{β} ↑ | 0.792 | 0.795 | 0.809 |
| E_{φ} ↑ | 0.927 | 0.929 | 0.933 |
| S_{α} ↑ | 0.869 | 0.873 | 0.874 |

Referring to Table 5, UniLearner enhances camouflaged object segmentation capability by leveraging cross-modal knowledge. If the “Know-Inject” process is disabled—i.e., the operation of integrating the latent vector z_{i→u} is removed—all metrics decrease significantly. This validates the effectiveness of UniLearner in improving the performance of camouflaged object segmentation by utilizing additional multi-modal data, enhancing the accuracy and consistency of segmentation results across multiple datasets.

### Generalization Capability of UniCOS

Table 6 presents an ablation study on applying the modules of the present invention to other COS methods: the modules proposed by UniSEG can easily convert single-modal COS methods into multi-modal ones, and improve performance through UniLearner and COS-irrelevant multi-modal data.

TABLE 6

| | CHAMELEON | | | | CAMO | | | | COD10K | | | | NC4K | | | |
|---|---|---|---|---|---|---|---|---|---|---|---|---|---|---|---|---|
| Methods | M ↓ | F [symbol] ↑ | E [symbol] ↑ | S [symbol] ↑ | M ↓ | F [symbol] ↑ | E [symbol] ↑ | S [symbol] ↑ | M ↓ | F [symbol] ↑ | E [symbol] ↑ | S [symbol] ↑ | M ↓ | F [symbol] ↑ | E [symbol] ↑ | S [symbol] ↑ |
| | Modify Native Single-Modal Method with Our Work | | | | | | | | | | | | | | | |
| FEDER (He et al., 2023) | 0.028 | 0.850 | 0.944 | 0.892 | 0.070 | 0.775 | 0.870 | 0.802 | 0.032 | 0.715 | 0.892 | 0.810 | 0.046 | 0.808 | 0.900 | 0.842 |
| FEDER in UniSEG-D | 0.026 | 0.852 | 0.950 | 0.902 | 0.070 | 0.779 | 0.871 | 0.810 | 0.031 | 0.739 | 0.902 | 0.838 | 0.043 | 0.806 | 0.907 | 0.855 |
| FEDER in UniCOS-I | 0.026 | 0.858 | 0.959 | 0.904 | 0.069 | 0.783 | 0.873 | 0.816 | 0.030 | 0.743 | 0.903 | 0.839 | 0.042 | 0.813 | 0.909 | 0.856 |

Modify Native Multimodal Method with Our Work

| | | | | | | | | | | | | | | | | |
|---|---|---|---|---|---|---|---|---|---|---|---|---|---|---|---|---|
| DaCOD (Wang et al., 2023a) | 0.026 | 0.829 | 0.939 | 0.893 | 0.051 | 0.831 | 0.905 | 0.855 | 0.028 | 0.740 | 0.907 | 0.840 | 0.035 | 0.833 | 0.924 | 0.874 |
| DaCOD in UniCOS-D | 0.024 | 0.857 | 0.945 | 0.904 | 0.050 | 0.836 | 0.910 | 0.861 | 0.026 | 0.771 | 0.925 | 0.849 | 0.034 | 0.840 | 0.927 | 0.878 |
| DaCOD in UniCOS-I | 0.023 | 0.865 | 0.951 | 0.908 | 0.050 | 0.839 | 0.917 | 0.863 | 0.025 | 0.783 | 0.929 | 0.856 | 0.034 | 0.847 | 0.930 | 0.882 |

[symbol]

indicates data missing or illegible when filed

As shown in Table 6, when the single-modal method FEDER is modified into a multi-modal method using the UniCOS-D scheme of the present invention, its performance is improved. Furthermore, when the UniCOS-I scheme combined with UniLearner is applied to the modified FEDER and the original multi-modal method DaCOD, the performance is further enhanced. This result indicates that the method of the present invention can effectively utilize multi-modal data and exhibit excellent generalization capability in COS tasks. In addition, it demonstrates that the method of the present invention can serve as a plug-and-play framework to significantly improve the performance of COS tasks.

In summary, the technical key points and innovative contributions of the present invention include:
1. The present invention proposes UniCOS, a unified Multi-modal Camouflaged Object Segmentation (MCOS) framework that integrates a multi-modal segmenter UniSEG and a cross-modal knowledge learning plug-in UniLearner.
2. UniSEG fuses encoded multi-modal and image features in both the latent space and state space, and feeds the fused features back to the additional modal encoder to guide further feature extraction. This iterative fusion-feedback mechanism enhances contextual understanding and noise robustness, thereby improving segmentation performance.
3. UniLearner acquires cross-modal knowledge from task-irrelevant multi-modal data. It maps images to the target modal space to generate pseudo-modal content and mapping vectors. By embedding these vectors into UniSEG, UniLearner establishes cross-modal semantic associations, thereby improving segmentation performance.
4. Extensive experiments on multiple COS tasks demonstrate that the method of the present invention achieves state-of-the-art performance and features plug-and-play flexibility.

Addressing the shortcomings of existing methods in the field of multi-modal camouflaged object segmentation, the present invention proposes UniLearner to learn and utilize cross-modal information between images and different modalities, thereby improving the performance of Multi-modal Camouflaged Object Detection (MCOD). By embedding cross-modal semantic vectors into the segmenter and leveraging existing non-camouflaged multi-modal data, this framework can still enhance the performance of COS tasks in the absence of real multi-modal data containing camouflaged targets. The present invention proposes a general state space fusion mechanism that utilizes cross-state space features and Mamba's ability to select features from different modalities in a unified state space. This mechanism integrates and selectively extracts cross-modal features within the unified state space, thereby improving the performance of Multi-modal Camouflaged Object Segmentation (MCOS).

To fully utilize effective features, the present invention proposes a State Space Fusion Mechanism (SSFM) combined with a Cross State Space Model (CSSM) to uniformly integrate multi-modal features into a shared state space for efficient fusion. On this basis, the present invention further designs UniSEG, a unified network for MCOS tasks.

To avoid the interference of the uncertainty of pseudo-modal data on feature extraction, UniSEG adopts a Latent Space Fusion Module (LSFM) to perform preliminary feature fusion in the latent space, and feeds the fused results back to the subsequent layers of the additional modal encoder through a Feature Feedback Module (FFM) to provide targeted guidance for feature extraction. Finally, SSFM is used to further fuse cross-modal information in the state space. Through this fusion-feedback-fusion strategy, UniSEG can effectively extract and integrate key multi-modal information, improving the segmentation performance of MCOS tasks.

To more effectively use additional modal information to enhance the performance of COS tasks, the present invention proposes UniLearner, a framework for acquiring cross-modal knowledge from auxiliary RGB-X datasets. Notably, this auxiliary dataset is irrelevant to the COS task itself. UniLearner learns cross-modal mapping to generate pseudo-modal data and a semantically rich latent vector that maps RGB images to the auxiliary modality, thereby providing guidance for the segmentation network. By jointly optimizing UniLearner with the segmentation network, the framework can improve the quality of feature generation, thereby enhancing segmentation performance and achieving better results in cross-domain image conversion tasks.

UniSEG adopts a modular design, enabling it to serve as a plug-and-play enhancement component for existing segmentation networks. Its various modules can seamlessly convert single-modal segmentation networks into multi-modal segmentation networks. In addition, UniLearner can work collaboratively with dual-branch multi-modal segmentation networks to further improve segmentation performance through efficient cross-modal knowledge fusion.

All methods proposed in the present invention are plug-and-play, which can be easily applied to other methods to bring performance gains.

The specific application scenarios of the present invention include:
1. The method can be used to detect camouflaged animals in natural environments, improving the efficiency of ecological research and biodiversity conservation. In addition, the method can be used for steganography and watermark detection, identifying information hidden in images or videos, such as digital watermarks or steganographic content.
2. In the medical field, the method can be used to segment imperceptible lesions, such as tiny tumors, retinal lesions, or skin lesions, enhancing the ability of early disease detection. Furthermore, the method can be applied to microscopic image analysis, such as detecting parasites or microorganisms, which are usually difficult to distinguish from the background.
3. The method can be used for surface change detection, identifying geographical features camouflaged by vegetation or buildings, such as illegal mining sites or military bases. Additionally, the method can be utilized for forest fire monitoring, detecting early signals of smoke or fire sources in complex environments to improve disaster early warning capabilities.

An embodiment of the present invention further provides a storage medium for storing a computer program, which when executed by a processor, implements at least the aforementioned method.

An embodiment of the present invention further provides a control device, comprising a processor and a storage medium for storing a computer program; wherein the processor is configured to implement at least the aforementioned method when executing the computer program.

An embodiment of the present invention further provides a processor, which implements at least the aforementioned method when executing a computer program.

The storage medium may be implemented by any type of non-volatile storage device or a combination thereof. The non-volatile storage device may be Read-Only Memory (ROM), Programmable Read-Only Memory (PROM), Erasable Programmable Read-Only Memory (EPROM), Electrically Erasable Programmable Read-Only Memory (EEPROM), Ferromagnetic Random Access Memory (FRAM), Flash Memory, magnetic surface storage, optical disc, or Compact Disc Read-Only Memory (CD-ROM); the magnetic surface storage may be a magnetic disk storage or a magnetic tape storage. The storage medium described in the embodiments of the present invention is intended to include, but is not limited to, these and any other suitable types of memories.

In the several embodiments provided by the present invention, it should be understood that the disclosed systems and methods may be implemented in other ways. The device embodiments described above are merely illustrative. For example, the division of units is only a logical function division, and there may be other division methods in actual implementation, such as combining multiple units or components into another system, or omitting or not executing some features. In addition, the coupling, direct coupling, or communication connection between the components shown or discussed may be through some interfaces, and the indirect coupling or communication connection between devices or units may be electrical, mechanical, or in other forms.

The units described as separate components may or may not be physically separated, and the components shown as units may or may not be physical units, that is, they may be located in one place, or distributed across multiple network units; some or all of the units may be selected according to actual needs to achieve the purpose of the solution of this embodiment.

In addition, each functional unit in each embodiment of the present invention may be integrated into one processing unit, or each unit may exist alone as a separate unit, or two or more units may be integrated into one unit; the above-mentioned integrated units may be implemented in the form of hardware, or in the form of hardware plus software functional units.

A person of ordinary skill in the art can understand that: the implementation of all or part of the steps of the above method embodiments may be completed by program instructions related to hardware, and the aforementioned program may be stored in a computer-readable storage medium. When the program is executed, it executes the steps including the above method embodiments; and the aforementioned storage medium includes: mobile storage devices, ROM, RAM, magnetic disks, optical discs, and other various media that can store program codes.

Alternatively, if the integrated units of the present invention are implemented in the form of software functional modules and sold or used as independent products, they may also be stored in a computer-readable storage medium. Based on this understanding, the technical solutions of the embodiments of the present invention essentially or the part that contributes to the prior art may be embodied in the form of a software product. The computer software product is stored in a storage medium and includes several instructions to enable a computer device (which may be a personal computer, a server, or a network device, etc.) to execute all or part of the methods described in the various embodiments of the present invention. The aforementioned storage medium includes: mobile storage devices, ROM, RAM, magnetic disks, optical discs, and other various media that can store program codes.

The methods disclosed in the several method embodiments provided by the present invention may be combined arbitrarily without conflict to obtain new method embodiments.

The features disclosed in the several product embodiments provided by the present invention may be combined arbitrarily without conflict to obtain new product embodiments.

The features disclosed in the several method or device embodiments provided by the present invention may be combined arbitrarily without conflict to obtain new method embodiments or device embodiments.

The above content is a further detailed description of the present invention in combination with specific preferred embodiments, and it cannot be considered that the specific implementation of the present invention is limited to these descriptions. For those skilled in the technical field of the present invention, without departing from the concept of the present invention, several equivalent substitutions or obvious modifications can be made, and the performance or use is the same, which should all be regarded as belonging to the protection scope of the present invention.

1. A camouflaged object segmentation method assisted by arbitrary modalities, wherein the method comprises the following steps:
S1. extracting features: extracting features of RGB images and images of other modalities respectively through two branches of a multi-modal segmenter UniSEG;
S2. performing preliminary fusion: performing preliminary fusion of the features of the RGB images and the features of the other modal images through a Latent Space Fusion Module (LSFM);
S3. performing further fusion: performing deep fusion of the preliminarily fused features in a unified state space through a State Space Fusion Mechanism (SSFM) and a Cross State Space Model (CSSM);
S4. generating segmentation results: converting the fused features into final segmentation results through a decoder;
S5. learning cross-modal knowledge: learning the relationship between RGB and the other modalities by a cross-modal knowledge learning network UniLearner to generate pseudo-modal images and knowledge vectors;
S6. conducting joint training: injecting the knowledge of the cross-modal knowledge learning network UniLearner into the multi-modal segmenter UniSEG, thereby improving the segmentation performance of UniSEG.

2. The camouflaged object segmentation method assisted by arbitrary modalities according to claim 1, wherein in step S1, when extracting the features of the RGB images and the other modal images, a dual-branch encoder architecture is adopted, the first branch is used to extract the features of the RGB images, the second branch is used to extract the features of the other modal images, and the output features of the two branches have the same spatial resolution.

3. The camouflaged object segmentation method assisted by arbitrary modalities according to claim 1, wherein in step S2, the Latent Space Fusion Module (LSFM) performs weighted fusion of the features of the RGB images and the features of the other modal images to generate fused latent features, and enhances the expressive ability of the features through nonlinear activation functions and convolution operations.

4. The camouflaged object segmentation method assisted by arbitrary modalities according to claim 1, wherein in step S3, the State Space Fusion Mechanism (SSFM) selectively integrates features of different modalities in the unified state space, and the Cross State Space Model (CSSM) captures long-range dependencies between features of different modalities and balances the contribution of each modal feature through a gating mechanism.

5. The camouflaged object segmentation method assisted by arbitrary modalities according to claim 1, wherein in step S4, when generating the segmentation results, a multi-task decoder is adopted, the decoder combines the fused features and preliminary prediction results at each layer to gradually reconstruct the segmentation map, and provides additional supervision information through an edge reconstruction task to enhance the detail and boundary accuracy of the segmentation results.

6. The camouflaged object segmentation method assisted by arbitrary modalities according to claim 1, wherein in step S5, when learning cross-modal knowledge, the cross-modal knowledge learning network UniLearner maps RGB images to the target modal space through an encoder-decoder structure to generate pseudo-modal images and semantically rich latent vectors, and the latent vectors are used to guide the feature extraction and fusion process of the multi-modal segmenter UniSEG.

7. The camouflaged object segmentation method assisted by arbitrary modalities according to claim 1, wherein in step S5, the cross-modal knowledge learning network UniLearner optimizes its parameters through joint training, uses L1 norm loss to constrain the generation of pseudo-modal images, and injects the generated latent vectors into the feature fusion layer of the multi-modal segmenter UniSEG to enhance the utilization of cross-modal semantic information by the segmentation network.

8. The camouflaged object segmentation method assisted by arbitrary modalities according to claim 1, wherein in step S6, during joint training, a weighted loss function is adopted to optimize the multi-modal segmenter UniSEG and the cross-modal knowledge learning network UniLearner, the loss function includes segmentation loss, edge reconstruction loss and cross-modal generation loss to simultaneously improve segmentation performance and cross-modal knowledge learning effect.

9. The camouflaged object segmentation method assisted by arbitrary modalities according to claim 1, wherein the multi-modal segmenter UniSEG specifically includes a Feature Feedback Module (FFM), a State Space Fusion Mechanism (SSFM) and a Cross State Space Model (CSSM), wherein the Feature Feedback Module (FFM) feeds back the preliminarily fused features to the subsequent layers of the other modal encoders, dynamically adjusts feature weights through a gating mechanism to guide the other modal encoders in targeted feature extraction; the State Space Fusion Mechanism (SSFM) selectively integrates RGB image features and other modal features in the unified state space, captures long-range dependencies through a State Space Model (SSM), and balances the contribution of different modal features using a gating mechanism; the Cross State Space Model (CSSM) further fuses different modal features in the state space, enhances feature expression ability through depth convolution and nonlinear activation functions, and reduces feature redundancy by combining channel attention mechanism to improve the robustness and semantic richness of the fused features.

10. A computer program product, comprising a computer program, wherein the computer program implements the camouflaged object segmentation method assisted by arbitrary modalities according to claim 1 when executed by a processor.
